(19) United States
(12) Patent Application Publication
(10) Pub. No.: US 2014/0079922 A1
(43) Pub. Date: Mar. 20, 2014

(54) Methods for encapsulating Layer by Layer films and for preparing specialized optical films

(71) Applicant: Svaya Nanotechnologies, Inc, Sunnyvale, CA (US)

(72) Inventors: Benjamin Wang, Mountain View, CA (US); David Olmeijer, San Francisco, CA (US); Siglinde Schmid, San Jose, CA (US); Melissa Fardy, Belmont, CA (US); J. Wallace Parce, Palo Alto, CA (US); Kevin Krogman, Santa Clara, CA (US)

(73) Assignee: Svaya Nanotechnologies, Inc, Sunnyvale, CA (US)

(21) Appl. No.: 14/028,450

(22) Filed: Sep. 16, 2013

Related U.S. Application Data
(60) Provisional application No. 61/702,121, filed on Sep. 17, 2012.

(51) Int. Cl. C09D 7/12

(52) U.S. Cl. CPC C09D 7/1291
USPC 428/201; 427/372.2; 427/385.5; 156/701; 427/379; 523/210; 428/317.9; 428/206

(57) ABSTRACT

Durable coatings and methods for producing the same are provided, where the coatings may include porous coatings encapsulated with a hardening solution that permeates into the porous structure of the film prior to curing. Curing of the hardening solution within the film provides for a durable coating having sufficient durability for use in many different applications, such as optical applications. Any convenient porous coatings may be used in the subject methods. Also provided are methods for forming a coating formulation, where the formulation includes porous coating particles dispersed in a carrier and the porous coating particles may be optionally encapsulated with a hardening solution prior to dispersion.

### CROSS REFERENCE TO RELATED APPLICATIONS

This application claims priority to U.S. Provisional Application 61/702,121, filed Sep. 17, 2012, the contents of which is incorporated herein in its entirety.

### INTRODUCTION

Porous coatings have been assembled from nanoparticle suspensions using a porous coating technique called “layer-by-layer assembly”. The process utilizes self-limiting complementary interactions, such as electrostatic pairs or hydrogen bonding donors and acceptors, to create the film. A drawback of the technique is that the films typically do not provide sufficient mechanical or environmental strength for many applications, such as optical films. This is further complicated when the technique is used with polymeric substrates, where restrictions on processing (thermal, radiative, chemical) may be greater, limiting the number of methods to improve durability.

### SUMMARY

Durable coatings and methods for producing the same are provided, where the coatings may include porous coatings encapsulated with a hardening solution that permeates into the porous structure of the film prior to hardening. Hardening of the hardening solution within the film provides for a durable coating that finds use in many different applications, such as a variety of optical applications including dichroic mirrors, high performance pigments, or solid state color filters. Any convenient porous coatings may be used in the subject methods. Also provided are methods for forming a coating formulation, where the formulation includes porous coating particles dispersed in a carrier, and the porous coating particles may optionally encapsulated with a hardening solution prior to dispersion.

In one aspect the invention provides a method for producing an encapsulated coating, comprising: (a) applying a hardening material to a surface of a porous coating, wherein the porous coating comprises an open pore structure and a plurality of bilayers disposed on a substrate, and wherein the hardening material permeates into at least a portion of the open pore structure of the porous coating; and (b) applying hardening conditions to harden the hardening material and form the encapsulated coating comprising hardened hardening material disposed on the surface of the porous coating and within at least a portion of the open pore structure of the porous coating.

In embodiments:

The hardening material permeates to a depth of less than about 50 nm below the surface of the porous coating.

The hardened hardening material is a transparent, semi-transparent, or opaque solid material. For example, the hardened hardening material is a semi-transparent or opaque solid material.

The hardening material permeates through the open pore structure of the porous coating to contact the substrate.

The hardening material is selected from a polymer, a crosslinkable polymer, a polymerizable monomer, an adhesive, and combinations thereof.

The method further comprises delaminating the encapsulated coating from the substrate to form a free standing film.

An adhesion promoter is present on the surface of the porous coating prior to applying the hardening material.

The method further comprises depositing the plurality of bilayers in a layer-by-layer fashion and drying the porous coating prior to applying the hardening material.

The encapsulated coating is more durable compared with the porous coating lacking the hardened hardening material.

The hardening material is applied as part of a hardening solution. The hardening solution further comprises a solvent. The hardening solution further comprises additional components such as a permeation enhancer.

The hardening comprises applying a hardening stimulus.

The hardening comprises waiting a period of time.

The hardening material permeates to a depth of less than about 50 nm below the surface of the porous coating, and the hardened hardening material is a semi-transparent or opaque solid material.

The hardening material permeates to a depth of less than about 50 nm below the surface of the porous coating, and the method further comprises depositing the plurality of bilayers in a layer-by-layer fashion and drying the porous coating prior to applying the hardening material.

The hardening material permeates to a depth of less than about 50 nm below the surface of the porous coating, and the hardening comprises applying a hardening stimulus or waiting a period of time.

The hardening material permeates to a depth of less than about 50 nm below the surface of the porous coating, and the encapsulated coating is more durable compared with the porous coating lacking the hardened hardening material.

The method further comprises depositing the plurality of bilayers in a layer-by-layer fashion and drying the porous coating prior to applying the hardening material, and the encapsulated coating is more durable compared with the porous coating lacking the hardened hardening material.

The method further comprises depositing the plurality of bilayers in a layer-by-layer fashion and drying the porous coating prior to applying the hardening material, and the hardening comprises applying a hardening stimulus or waiting a period of time.

In another aspect, the invention provides a coating material comprising particles of a first material dispersed in a carrier, wherein the particles comprise a plurality of bilayers and a porous structure.

In embodiments:

The porous structure is an open pore structure.

Each bilayer of the plurality of bilayers comprises a pair of complementary materials capable of forming a chemical bond.

Each bilayer of the plurality of bilayers comprises nanoparticles and a polyelectrolyte, and wherein the polyelectrolyte is capable of forming a crosslinked network upon application of heat, UV energy, waiting time, chemical reactant, or a combination thereof.

The particles further comprise a hardened hardening material that is at least partially disposed within the porous structure of the first material.

The porous structure is an open pore structure and each bilayer of the plurality of bilayers comprises a pair of complementary materials capable of forming a chemical bond. Examples of chemical bonds include covalent bonds, ionic bonds, and hydrogen bonds.

In another aspect, the invention provides a method for forming a coating material comprising particles of a first material dispersed in a carrier, wherein the particles comprise a plurality of bilayers and a porous structure, the method comprising: (a) depositing the plurality of bilayers on a substrate to form a porous coating comprising a porous structure; (b) drying the porous coating for a predetermined period of time; (c) delaminating the porous coating from the substrate to form particles; (d) dispersing the particles in the carrier.

In embodiments:

The method further comprises depositing a hardening material on the porous coating after the predetermined period of time and hardening the hardening material.

The delaminating is mechanical, chemical, thermal, environmental, or a combination thereof.

The carrier is selected from a crosslinkable formulation, a thermoset formulation and a thermoplastic formulation, or combinations thereof.

In another aspect, the invention provides an article comprising, in order: a first substrate; a porous coating comprising a plurality of bilayers and having an open pore structure, wherein at least a portion of the bilayers comprise nanoparticles and a polyelectrolyte; and a laminating material.

In embodiments:

The article further comprises a second substrate contacting the laminating material.

The article further comprises a laminating material disposed between the first substrate and the porous coating.

The substrate is capable of acting as a laminating material.

The substrate is patterned, the porous coating is patterned, the laminating material is patterned, or a combination of the substrate, porous coating, and laminating material is patterned.

Further aspects of the invention include the following.

A method for producing a durable coating. In some embodiments, the method includes: depositing a plurality of bilayers (wherein, for example, a bilayer comprises a layer of a first material and a layer of a second material assembled via layer by layer assembly) on a substrate to form a porous coating; encapsulating the coating by applying a hardening solution to the coating, where the hardening solution permeates at least partially into the pores of the coating; and hardening the hardening solution to form a durable coating.

In embodiments:

The hardening solution can be cured or dried to form a crosslinked or set material.

The hardening solution hardens to form a clear solid material. In some embodiments the hardening solution hardens to form a black or opaque solid material.

The hardening solution permeates through the coating to contact the substrate.

The plurality of bilayers are deposited using a pair of deposition solutions, where one deposition solution includes a solvent and a polyelectrolyte, and the other deposition solution includes a solvent and nanoparticles. In some embodiments the deposition is via spray application in a layer-by-layer fashion. In some embodiments further includes drying the coating prior to encapsulation. In some embodiments the coating includes nanoparticles and a polymeric binder. In some embodiments the durable coating includes a crosslinked material permeating at least a portion of the bilayers.

The hardening solution includes a hardening material selected from a crosslinkable polymer, a polymerizable monomer, and an adhesive. In some embodiments the hardening material is a functional material, and is selected from a liquid crystalline material, a conductive material, an energy absorbing material, a fluorescent material, a thermochromic or photochromic material, and a piezoelectric material.

The subject method further includes delaminating the durable coating from the substrate to form a free standing film.

A TEFLON® or other non-stick film (either free-standing or as a coating on a substrate) is hardcoated using the methods disclosed herein. A layer-by-layer film is then deposited onto the TEFLON® film. A hardcoat film is then deposited on the LbL film, and the TEFLON® film is removed to produce a hardcoated LbL film.

Another aspect of the present disclosure includes a coating, for example, a coating produced by a method described herein. In some embodiments, the subject coating includes a porous coating comprising a plurality of bilayers, where each bilayer includes nanoparticles and a polyelectrolyte, and a hardened material at least partially disposed within the pores of the film. In some embodiments the nanoparticles and polyelectrolyte are held together by an attractive force selected from electrostatic forces, Van der Waals forces, hydrogen bonding, and specific binding forces, or a combination thereof.

In embodiments:

The porous coating is disposed on a substrate. In some embodiments the hardened material is further disposed on the porous coating as an encapsulating layer.

At least a first portion of bilayers has a refractive index n1 and at least a second portion of bilayers has a refractive index n2. Generally, n1 and n2 are independently selected and can be less than 1.33, between 1.33 and 2.06, or greater than 2.06. In some embodiments the first portion and second portion of bilayers alternate in the porous coating. In some embodiments the first portion of bilayers are grouped into a plurality of first groups, the second portion of bilayers are grouped in to a plurality of second groups, and the first and second groups alternate in the porous coating.

The hardened hardening material is opaque. In some embodiments the hardened hardening material is transparent or semi-transparent.

Another aspect of the invention is an article that includes a substrate, a porous coating containing a plurality of bilayers, where each bilayer includes nanoparticles and a polyelectrolyte disposed on the substrate, and a hardened hardening material at least partially disposed within the pores of the film. In some embodiments, the porous coating is a multilayer stack. In some embodiments, the porous coating is a dichroic mirror or dichroic filter.

Another aspect of the invention is a method for forming a coating formulation. In some embodiments, the subject method includes depositing a plurality of bilayers on a substrate to form a porous coating, allowing the porous coating to dry for a predetermined period of time, delaminating the porous coating from the substrate to form porous coating particles, and dispersing the porous coating particles in a carrier to form the coating formulation. In some such embodiments, the method further includes applying a hardening solution to the porous coating and applying hardening conditions such that at least one component in the hardening solution reacts as described herein.

In embodiments:

The subject method further includes depositing an encapsulating coating on the porous coating. In some such embodiments the deposition is carried out after the porous coating has dried for a predetermined time. In some embodiments, in the subject method at least one component of the hardening solution enters at least a portion of the pores of the porous coating. In some embodiments, the subject method further includes hardening the encapsulating coating after deposition on the porous coating.

The porous coating is mechanically delaminated by scraping the substrate with a blade, or by flexing or bending the substrate, or by application of a stream of gas or liquid.

The porous coating is delaminated by dissolving, disintegrating or melting the substrate, or a sacrificial layer on the substrate. In some embodiments the porous coating is removed from the substrate by contact with a fluid. In some embodiments the porous coating is delaminated through a combination of mechanical and dissolving methods.

The carrier is selected from a cosmetic base, a paint base, an adhesive, caulk filler, etc. In some embodiments the carrier is selected from a crosslinkable formulation, a thermoset formulation, a thermoplastic formulation, etc. In some embodiments the dispersion of porous coating particles in a carrier occurs at temperatures above room temperature.

Each bilayer includes nanoparticles and a polyelectrolyte.

The nanoparticle material and the electrolyte material are selected such that a first portion of bilayers has a refractive index of n1 and a second portion of bilayers has a refractive index n2.

The polyelectrolyte is capable of forming a crosslinked network upon application of heat, UV energy, or chemical reactant.

The substrate is reused after the porous coating is delaminated.

The porous coating particles are in the form of flakes, microparticles, or a powder.

The subject method further includes milling, processing, grinding, or ablating the porous coating particles to a desired particle morphology (including, but not limited to, size, size distribution, shape, aspect ratio, and the like) prior to dispersing in the carrier.

The particles after milling have an average diameter [i.e. largest dimension] in the range 1-10000 μm.

The porous coating particles are dispersed in the carrier in an amount in the range of 1-100 mg particles per 1 g carrier.

The subject method further includes applying the coating formulation to a substrate.

Another aspect of the invention is a coating material that includes particles of a first material dispersed in a second material. In some embodiments the first material includes nanoparticles and a polyelectrolyte and the second material includes a carrier. In some embodiments the second material alters one or more optical properties of the first material.

In embodiments:

The particles of the first material include a plurality of bilayers, where each bilayer includes the polyelectrolyte and the nanoparticles.

The plurality of bilayers are held together by attractive forces between the polyelectrolyte and the nanoparticles, for example, attractive forces such as electrostatics, Van der Waals, hydrogen bonding, and specific binding forces, or a combination thereof.

The polyelectrolyte is crosslinked. In some embodiments the polyelectrolyte is not crosslinked.

The first material is porous. In some embodiments the first material further includes an encapsulating material that is at least partially disposed within the pores.

Another aspect of the invention is an article that includes a substrate that can act as a laminating material between two surfaces, and a porous coating that includes a plurality of bilayers, where each bilayer includes nanoparticles and a polyelectrolyte, where the porous coating is disposed on at least one side of the substrate. In some embodiments, the porous coating is disposed on both sides of the substrate. The coated substrate may be positioned between two surfaces (i.e., materials to be laminated) to form a laminate. Other configurations of substrates, coatings and materials to be laminated may also be used, for example, a coating may be positioned between two substrates, or a material to be laminated may be positioned between two substrates, where each substrate is independently coated or uncoated. Each substrate, coating and material to be laminated can be individually positioned in order to provide desired properties in the laminate.

### DETAILED DESCRIPTION

The invention provides durable coatings and methods for producing the same. In some embodiments, the subject methods include the encapsulation of porous coatings via the permeation of a hardening solution into the porous structure of the film and subsequent hardening of the solution or a component therein. The porous coatings may be produced using a layer-by-layer method, or the porous coatings may be produced using other film-forming techniques. Without wishing to be bound by theory, in some embodiments the durability of the porous coating is increased by a continuous network of hardened encapsulant that forms upon curing throughout at least a portion of the porous structure of the coating. The optical behavior of the film may be controllably changed, for example by adjusting the percentage of the pores, or the volume of the porous structure, that is filled with the encapsulant, or also by selecting desirable optical properties of the encapsulant (for example, the refractive index or polarizability of the hardening solution). In some embodiments, the hardening solution permeates throughout the film and optionally to the substrate. In some embodiments excess hardening solution remains disposed on top of the porous coating (i.e., as an outermost coating layer). In some embodiments, the encapsulation process may also be used to add functionality to the porous coating.

As used herein, the terms “hard” “durable” and “durability” refer to the ability of a coating material to resist a stress or force, possess increased toughness, viscosity, modulus, or other material properties known in the art, or to resist deterioration, damage or degradation during a predetermined period of time, e.g., the lifetime of the material. The durability of a coating material may be characterized by its ability to maintain one or more properties of the material, such as but not limited to, appearance, strength, or an optical property (e.g., reflectance or haze). Appearance may be assessed by the observation of defects such as cracks, wrinkles and fogging. Strength may be assessed by any convenient standard test, e.g., the pencil test for film hardness (ISO 15184). In a durable coating such as those of the invention, such properties may be maintained over an extended period of time, such as, 1 day or more, 1 week or more, 1 month or more, 2 months or more, 3 months or more, 4 months or more, 5 months or more, 6 months or more, 12 months or more, 18 months or more, or even 24 months or more.

In some embodiments, the subject methods include depositing a plurality of bilayers on a substrate to form a porous coating, encapsulating the coating by applying a hardening solution that permeates into the pores of the coating, and hardening the hardening solution to form a durable coating. In some embodiments, hardened hardening material completely fills the pores of the porous coating. In other embodiments, hardened hardening material partially fills the pores of the porous coating. In some embodiments, the encapsulated coating is more than 2, 3, 4, 5, 10, or more than 15 times more durable (e.g., harder or more scratch resistant) compared with the porous coating without the hardened hardening material.

Also provided are methods for forming coating formulations, where the formulations include porous coating particles dispersed in a carrier. The porous coating particles may be optionally encapsulated with a hardening solution prior to dispersion in the carrier.

The encapsulation methods and compositions described herein are appropriate for polymeric nanocomposites which contain porosity. Any convenient porous coating may be used in the subject methods, coatings, and coating formulations, so long as such porous coating is suitable for the intended use.

### Hardening Solution

Herein described is the hardening solution. Any convenient hardening solution may be used in the subject methods, so long as they perform the intended function as described herein. In some embodiments, the hardening solution is any material that will have an increased hardness, strength, modulus or viscosity following the application of suitable hardening conditions, e.g., drying, heating, waiting time, crosslinking, chemical treatment, irradiation with light (e.g., UV irradiation), electron radiation, ionizing radiation or electrochemical conditions (e.g., oxidation or reduction). Unless otherwise indicated, use of the term “solution” is not meant to require a multi-component system (e.g., a solvent and solute). The hardening solution is, in some embodiments, a single component material consisting only of the hardening material.

In some embodiments, the hardening solution is a liquid prior to hardening. Following application of the hardening solution to the porous coating, the solution permeates into the pores of the porous coating, thereby encapsulating the coating. In some embodiments, the hardening solution is made to be fluid prior to hardening. For example, disposing a “thermal laminating pouch” (Scotch™ 3M) around a porous coating, and processing the pouch in a “thermal laminator” (Scotch™ 3M), results in an encapsulated coating. As used herein, the term “encapsulant” refers to the material that encapsulates the porous coating, and may be used to refer to both the hardening solution that permeates into the pores of a porous coating, and the resulting hardened material that forms after a hardening step.

In some embodiments, the hardening solution permeates through the porous coating to contact the substrate. In some embodiments, the hardening solution permeates through at least a portion of the bilayers of the porous coating. In some embodiments, the hardening solution may contact approximately 1% or more, such as equal to or more than 5, 10, 20, 30, 40, 50, 60, 70, 80, or 90%, or equal to or less than 90, 80, 70, 60, 50, 40, 30, 20, 10, or 5% of the porous structure of the coating. In some embodiments, the hardening solution permeates through the porous coating to completely fill the porous structure of the coating. In some embodiments, the hardening solution permeates through the porous coating to a depth of approximately 5% or more of the total thickness of the coating, such as equal to or more than 10, 20, 30, 40, 50, 60, 70, 80, or 90%. In some embodiments, the hardening solution permeates to a depth within the porous coating (i.e., below the surface of the porous coating) that is less than about 1000, 500, 400, 300, 200, 100, 75, 50, 25, or 10 nm.

In some embodiments, the residual hardening solution (i.e., the hardening solution that is disposed on the porous coating, rather than within the pores of the porous coating) may be disposed on the porous coating to a thickness of approximately 1% or more of the total thickness of the coating, such as 10% or more, 100% or more, 1000% or more, or even 10,000% or more of the total thickness of the coating.

The hardening solution comprises one or more components which are described in more detail herein. The hardening solution is capable of being hardened upon application of suitable conditions (“hardening conditions”). As used herein, the phrase “hardening the hardening solution” refers to a process of exposing the hardening solution to hardening conditions such that at least one component of the hardening solution reacts (e.g. hardens or cures). Unless clear from the context, the phrase does not necessarily require or imply that all components of the hardening solution react—i.e., one or more components of the hardening solution (such as a solvent, an additive, or a portion of a crosslinkable material) may remain unreacted. Thus, the phrase means that at least one component of the hardening solution reacts to form a hardened material.

Any convenient hardening conditions may be used in the subject methods to harden or cure the hardening solution, e.g., drying, heating, crosslinking, chemical treatment, irradiation with light (e.g., UV irradiation), electron radiation, ionizing radiation or electrochemical conditions (e.g., oxidation or reduction). In some embodiments, the hardening conditions are ambient conditions, and hardening the hardening solution involves waiting a period of time for hardening to occur. Exemplary conditions are set forth herein. In some embodiments, hardening of the hardening solution results in a liquid, gel, or liquid crystal material that has increased viscosity, modulus or yield stress. In some embodiments, hardening of the hardening solution results in a solid material that has increased hardness, strength or modulus.

In some embodiments, application of the hardening conditions to the hardening solution is performed prior to application of the solution to the porous coating, for example, by mixing a chemical reagent with the solution immediately prior to application to the porous coating. In some such cases, hardening of the solution occurs relatively slowly compared to permeation of the solution into the porous structure of the coating. In other such cases, initiation of the hardening reaction may further require an additional stimulus, such as heat or the application of UV radiation.

In some embodiments, the hardening solution includes an hardening material selected from a polymer (e.g., a crosslinkable polymer), a polymerizable monomer or oligomer, and an adhesive.

In some embodiments, the hardening solution contains one or more polymerizable monomers or oligomers and hardening includes polymerizing the monomer or oligomer to produce a linear or three dimensional polymer network. A variety of monomers, oligomers and polymerization chemistries may be used. Polymerization may be initiated or controlled by the application of suitable conditions, such as, UV irradiation, heat, electron radiation, ionizing radiation, or a chemical reagent (e.g., a radical initiator), or a combination thereof.

Any convenient polymerizable functional groups may be used in the subject monomers and oligomers. Exemplary polymerizable functional groups include: unsaturated polymerizable functional groups such as, ethylenic unsaturated groups capable of undergoing addition reaction/polymerization reaction by a radical species (e.g. (meth)acryloyl, allyl, styryl and vinyloxy groups), and cationically polymerizable groups (e,g, epoxy, oxetanyl and vinyloxy groups). Specific examples of polymerizable functional monomers include: (meth)acrylate diesters of alkyleneglycol such as neopentylglycol acrylate, 1,6-hexanediol (meth)acrylate and propyleneglycol di(meth)acrylate; (meth)acrylate diesters of polyoxyalkyleneglycol such as triethyleneglycol di(meth)acrylate, dipropyleneglycol di(methacrylate), polyethyleneglycol di(meth)acrylate and polypropyleneglycol di(meth)acrylate; (meth)acrylate diesters of polyhydric alcohol such as pentaerythritol di(meth)acrylate; and (meth)acrylate diesters of ethylene oxide or propylene oxide adduct such as 2,2-bis {4-(acryloxy-diethoxy}phenyl propane and 2-2-bis{4-(acryloxy-polypropoxy)phenyl}propane. Further exemplary photopolymerizable functional monomers include epoxy (meth)acrylates, urethane (meth)acrylates and polyester (meth)acrylates. In some cases, the monomer is a polyfunctional monomer that has 3 or more (meth)acryloyl groups per molecule. Specific examples of such monomers include: trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, dipentaerythritol triacrylate, dipentaerythritol pentacrylate, dipentaerythritol tetra(meth)acrylate, dipentaerythritol hexa(meth)acrylate, tripentaerythritol triacrylate and tripentaerythritol hexatriacrylate.

Two or more kinds of monomers and/or oligomers can be used together. For polymerization reactions of photopolymerizable monomers, an initiator (e.g., a photoradical initiator or photocationic initiator) may be used. Examples of photoradical initiators include acetophenones, benzophenones, Michler's benzoyl benzoates, alpha-amyloxime esters, tetramethylthiuram monosulfides and thioxanthones.

In some embodiments, the hardening of the hardening solution includes crosslinking, where crosslinking may be via direct covalent linkages or via a crosslinker compound. In some embodiments, the hardening solution contains a crosslinkable polymer that can be cured to form a crosslinked polymer material. Crosslinking may be achieved by any suitable curing method, for example, by addition of a crosslinking reagent to the hardening solution, irradiation with light (e.g., using photochemically active functional groups to form crosslinks), electron beam, or application of heat, or a combination thereof.

In some embodiments, the hardening solution contains one or more polymers, and hardening includes drying of the solution without crosslinking.

Exemplary polymers for use in hardening solutions include, but are not limited to, polyethylene terephthalate (PET), polycarbonate (PC), triacetyl cellulose (TAC), polymeric methyl methacrylate (PMMA), methyl methacrylate styrene copolymer (MS), cyclic olefins copolymer, polyethylene glycol, and polyvinylpyrrolidone (PVP).

In some embodiments, the hardening solution contains an adhesive. The adhesive-containing hardening solution may be in a liquid or semi-liquid state that is capable of permeating into the porous structure of the coating prior to hardening. In some embodiments, the hardening solution includes a non-reactive adhesive (e.g., a drying adhesive, a pressure sensitive adhesive (PSA), a contact adhesive or a hot melt adhesive). In some embodiments, the hardening solution includes a reactive adhesive that hardens via chemical reactions between two or more components (e.g., by crosslinking, UV light curing, heat curing or moisture curing).

Exemplary adhesives that may be used in the subject methods and coating include, but are not limited to, synthetic adhesives (e.g., polychloroprene, ethylene-vinyl acetate, polyvinyl acetate, epoxy, polyurethane, polyurethane-polyester, polyurethane-polyol, polyurethane-based, cyanoacrylate and acrylic based adhesives), and natural or bio-adhesives (rubber, starch, dextrins, casein, etc.).

The hardening solution may further include one or more ingredients such as, but not limited to, a solvent, a chemical reagent (e.g., a catalyst, an initiator, a photoreactive substance) and/or one or more excipients (e.g., resins, adhesion promoters, stabilizers, pigments, fillers, softeners, waxes, water-binding agents, flow control agents, etc.). Examples of catalysts include polymerization catalysts, hydrogenation catalysts, dehydration catalysts, and the like. Examples of initiators include polymerization initiators such as radical initiators and the like.

Exemplary ingredients for use in the subject hardening solutions are now described. The hardening solution may include a filler such as inorganic fine particles (e.g., titanium dioxide). In some embodiments, by including a filler, the refractive index or strength of the resulting hardened hardening material is adjusted. Any convenient solvents can be used, such as polar protic solvents, polar aprotic solvents, and non-polar solvents. Examples of polar protic solvents include water and organic solvents such as alcohols (ethanol, methanol, etc.) and acids (formic acid, etc.). Examples of polar aprotic solvents include ethers such as tetrahydrofuran, dimethyl ether, and diethyl ether, sulfoxides such as dimethyl sulfoxide, and amides such as dimethyl formamide. Examples of non-polar solvents include alkanes such as hexane and pentane. In some embodiments, mixtures of such solvents are also suitable. Exemplary solvents include but are not limited to, alcohols such as ethanol, propanol, butanol, pentanol, hexanol, octanol, nonanol, benzyl alcohol, methylcyclohexanol, ethanediol, propanediol, butanediol, pentanediol, hexanediol, octanediol, and hexanetriol; esters such as butyl formate, pentyl formate, methyl acetate, ethyl acetate, propyl acetate, butyl acetate, pentyl acetate, hexyl acetate, benzyl acetate, 3-methoxybutyl acetate, 2-ethylbutyl acetate, 2-ethylhexyl acetate, methyl propionate, ethyl propionate, propyl propionate, butyl propionate, and pentyl propionate; amides such as dimethylformamide, dimethylacetoamide, diethylformamide, and diethylacetoamide; ketones such as dimethyl ketone, methyl ethyl ketone, pentanone, hexanone, methyl isobutyl ketone, heptanone, and diisobutyl ketone; nitrites such as acetonitrile; ethers such as diethyl ether, dipropyl ether, diisopropyl ether, dibutyl ether, and dihexyl ether; cyclic ethers such as anisole, tetrahydrofuran, and tetrahydropyran; ethylene glycol ethers such as dimethoxyethane, diethoxyethane, dibutoxyethane, diethylene glycol dimethyl ether, diethylene glycol diethyl ether, and ethylene glycol dibutyl ether; acetals such as methylal and acetal; paraffinic hydrocarbons such as pentane, hexane, heptane, octane, nonane, decane, and dodecane; cyclic hydrocarbons such as toluene, xylene, ethylbenzene, cumene, mesitylene, tetralin, butylbenzene, cymene, diethylbenzene, pentylbenzene, dipentylbenzene, cyclopentane, cyclohexane, methylcyclohexane, ethylcyclohexane, and decalin; and halogenated hydrocarbons such as chloromethane, dichloromethane, trichloromethane, tetrachloromethane, chloroethane, dichloroethane, trichloroethane, tetrachloroethane, pentachloroethane, chloropropane, dichloropropane, trichloropropane, chlorobutane, dichlorobutane, trichlorobutane, chloropentane, chlorobenzene, dichlorobenzene, chlorotoluene, dichlorotoluene, bromomethane, bromopropane, bromobenzene, and chlorobromoethane. Mixtures of any of the aforementioned solvents may also be used.

In some embodiments, the hardened hardening material includes all of the components of the hardening solution prior to hardening. In other embodiments, one or more of the components from the hardening solution is not present in the hardened hardening material. For example, in some embodiments, a solvent is present in the hardening solution but is not present in the hardened hardening material. In some embodiments, the hardened hardening material is at least partially disposed within the pores of the porous coating. As used herein, the term “encapsulating layer” refers to a layer of encapsulant material that is at least partially disposed within the pores of a porous coating. In some embodiments, the encapsulating layer includes encapsulant that is at least partially disposed within the pores of a porous coating, and also that is disposed on the surface of the underlying porous coating. In some embodiments, the encapsulant is a hardened hardening material, although the term “encapsulating layer” refers to the layer of encapsulant material at both of the following times: (a) before any hardening reaction has occurred; and (b) after reaction (e.g. hardening) of the encapsulant material. In some embodiments, the encapsulating layer may be referred to as a durable coating.

In some embodiments, the hardened hardening material of an encapsulated coating is disposed through at least a portion of the bilayers of the porous coating, and the encapsulated coating is a durable coating. In some embodiments, in the durable coating, the hardened hardening material is disposed through approximately 10% or more of the bilayers of the coating, such as 20, 30, 40, 50, 60, 70, 90%, or even 100% of the bilayers. In some such embodiments the hardened hardening material extends entirely through the porous coating to reach the underlying substrate when a substrate is present. In some embodiments, the hardened hardening material permeates to a depth within the porous coating (i.e., below the surface of the porous coating) that is less than about 1000, 500, 400, 300, 200, 100, 75, 50, 25, or 10 nm.

The porosity of the porous coating and/or the degree of permeation of the hardening solution into the porous structure may be selected to control the degree of contact between the hardening solution and the porous coating and provide for a particular property of the coating that is produced (e.g., a desired strength or durability).

In some embodiments, the hardening solution includes a functional material that provides for a particular property or function of the durable coating. In some embodiments, the functional material of the hardening solution is selected from a liquid crystalline material, a conductive material, an energy absorbing material, a fluorescent material, a thermochromic or photochromic material, and a piezoelectric material. In some embodiments, the functional material and the hardening material are the same. In some embodiments, the functional material is added to the solution in addition to the hardening material.

In some embodiments, the functional material is a conductive material (e.g., a conductive polymer) and provides for conductivity in the resulting coating.

In some embodiments, the functional material is a dielectric material that can be polarized by an applied electric field. Such durable coatings may find use in optical switches, capacitors and dielectric resonators.

In some embodiments, the functional material is piezoelectric material. Such durable coatings may find use in applications such as the production and detection of sound, generation of high voltages, electronic frequency generation, microbalances, and ultrafine focusing of optical assemblies.

In some embodiments, the hardening solution contains liquid crystals and provides for a desired optical property in the resulting coating (e.g., birefringence, a particular refractive index, reflectance). In some embodiments, the liquid crystals are thermotropic such that the resulting coating is responsive to changes in temperature (e.g., a change in temperature may result in an observable difference in, or a change in the optical properties of the coating).

In some embodiments, the functional material is an optical material (e.g., a pigment, a dye, chromophore or a fluorophore). In some embodiments, the hardening solution hardens to form a black or opaque solid material. In some embodiments the hardening solution is spray paint (e.g., black, clear, or colored paint). In some embodiments, the use of black spray paint is used with a clear substrate. In some embodiments, the hardening solution hardens to form a clear solid material. In some embodiments, the hardening solution is a clear coat, such as that used as a hardcoat formulation, clear lacquer, transparent sealant, or a clear nailpolish. The hardening solution may harden to form a hardened hardening material (e.g., a hardened polymeric binder) that is opaque, transparent or semi-transparent. In some embodiments, the hardened hardening material forms a porous encapsulation layer over the underlying porous coating, whereas in other embodiments, the hardened hardening material forms a non-porous encapsulation layer over the underlying porous coating. In some embodiments, the hardened hardening material is crosslinked, glassy, and/or set.

In some embodiments, the hardened hardening material forms a protective barrier for the porous coating, e.g., against oxygen and/or water.

In some embodiments, the hardening solution includes a functional material, that has a biological property, e.g., a specific binding moiety, an antibacterial or antifungal material, a bio-disperant, a molecule with pharmacoactivity or a biocide. As used herein, the term “specific binding moiety” refers to a member of a specific binding pair, i.e. two molecules where one of the molecules through chemical or physical means specifically binds to the other molecule. Examples of specific binding pairs include biotin and streptavidin (or avidin), enzyme and substrate, ligand and receptor, and antigen and antibody, although specific binding pairs, e.g., nucleic acid hybrids, and polyhistidine and nickel are also envisioned. The specific binding pairs may include analogs, derivatives and fragments of the original specific binding members. Such functional materials may find use in coatings or membranes for sensors and applications where antifouling is desired (e.g., coatings or membranes that contact water).

In some embodiments, the hardening hardening material alters the refractive index of the porous coating after encapsulation. The composition of the hardening solution may be selected to provide for a desired change in the refractive index of the porous coating. In some embodiments, the hardening solution may alter the structure of the porous coating after encapsulation, for example, the hardened encapsulant may increase the overall thickness of the porous coating. Such changes in the physical structure may impart a desired change in the optical properties of the porous coating. In some embodiments, the design of the porous coating may be selected to accommodate the composition of the hardening solution.

In some embodiments, the hardened hardening material permeates to a depth within the porous coating such that the optical properties (e.g., refractive index, etc.) of the porous coating are substantially identical to the optical properties of the porous coating in the absence of the hardened hardening material. By substantially identical is meant that the optical properties are not more than 15, 10, 5, or 1% different. For example, the hardened hardening material permeates to a depth of less than 50 nm and the optical properties of the porous coating are not more than 5% different than the optical properties of the porous coating without the hardened hardening materials.

### Porous Coating

The present disclosure involves a porous coating. As used herein, the term “porous coating” refers to a porous coating covering a substrate, as well as any delamination products (e.g., films or particles) after a porous coating is removed from a substrate.

The porous coating may be an optical porous coating (i.e., a porous coating having certain optical properties, such as wavelength-selective reflectivity, a specific refractive index, etc.).

The porous coating may be applied to a surface of a substrate. Applying to a substrate surface includes the surface of a substrate itself as well as the surface of any coatings deposited on the substrate. Thus, for example, when a material is deposited on a substrate surface, the material may be deposited directly onto the surface of the substrate itself, or the material may be deposited onto the surface of a coating disposed on the substrate.

In some embodiments the porous coating comprises an open pore structure, meaning that the coating substantially consists of a network of interconnected pores or cavities (as compared with a closed pore structure, which substantially consists of individual pores that are not interconnected). The porous structure is determined by the structure of the material of the porous coating, e.g., by the layers of polymeric, monomeric and/or nanoparticle material that may be used to produce the layer-by-layer porous coating.

Pores may be spherical or may be asymmetrical in shape. The interconnected porous structure may extend throughout the porous coating, both vertically (i.e., substantially perpendicular to the plane of the porous coating layers) and horizontally (i.e., substantially parallel to the plane of the porous coating layers). In some embodiments, the porous structure is three dimensional (i.e., the interconnected cavities of the structure extend both horizontally and vertically throughout the porous coating). Two cavities or spaces are “interconnected” when a liquid, such as a hardening solution, can freely permeate between them, given sufficient capillarity or other permeation driving force. In some embodiments, the porous structure is not a plurality of air columns, i.e., pores disconnected from each other where each pore extends only in one dimension (e.g., vertically) through the structure. In some embodiments, the porous structure includes a regular arrangement of interconnected pores or cavities. In some embodiments, the porous structure is asymmetric, irregular or random. Without wishing to be bound by theory, the extent of porosity and nature of the porous structure of the porous coating may be selected to provide for an internal surface area having improved contacts with a hardening solution, to result in an encapsulated porous coating with increased durability. In such durable porous coatings, a continuous network of hardened encapsulant forms upon curing. In some embodiments, the extent and nature of the porosity may be selected such that the internal surface area for contacting the hardening solution is optimized without significantly reducing the inherent strength of the porous thin material prior to encapsulation.

In some embodiments, the porous coating is nanoporous, e.g., the porous coating includes an open pore structure having pore sizes of about 1 nm to about 1000 nm in diameter. In some embodiments, the porous coating is microporous, e.g., the porous coating includes a porous structure having pore sizes of about 1 μm to about 100 μm in diameter. In some embodiments, the porous coating has a porous structure that includes both nanoporous and microporous structures. In the some embodiments, the porous coating includes a porous structure having pore sizes of about 1 nm to about 100 μm in diameter, such as about 1 nm to about 1 μm, about 5 nm to about 500 nm, or about 10 nm to about 100 nm. In certain embodiments, the porous coating has an average pore size of between about 1 nm and about 1 μm, such as about 5 nm to about 500 nm, or about 10 nm to about 100 nm. In certain embodiments, the porous coating has a % porosity of between about 0.05% and about 70%, such as between about 0.1% and about 20%, between about 0.1% and about 5%, or between about 0.1% and about 2%. In certain embodiments, the porous coating has a % porosity of 70% or less, such as 40% or less, 30% or less, 20% or less, 10% or less, 5% or less, 4% or less, 3% or less, 2% or less, or 1% or less. In certain embodiments, the porous coating has a % porosity of 0.05% or more, such as 0.1% or more, 0.5% or more, 1% or more, 2% or more, 3% or more, 4% or more, 5% or more, 10% or more, 20% or more, 30% or more, or 40% or more.

In some embodiments, the porous coating is disposed on a substrate. Any convenient substrate material and substrate form (e.g., a flat or curved surface, a mesh, or a surface including a pattern of structural features) may be used in preparing a subject film. The substrate may be opaque, transparent or semi-transparent. The substrate may be flexible or rigid. The porous coating may be disposed onto any convenient surface of the substrate. Exemplary substrate materials include, but are not limited to, quartz, silica, glass, optical glasses, metals, alloys, stainless steel, ceramics, silicon, a semiconductor material, synthetic and naturally occurring woven and non-woven fibers, and plastics such as polyethylene (PE), polycarbonate (PC), polypropylene (PP), polymeric methyl methacrylate (PMMA), methyl methacrylate styrene copolymer (MS), acrylonitrile butadine styrene (ABS), polystyrene (PS), polyethylene terephthalate (PET), polyacetal, polyoxy methylene (POM) or Nylon.

In some embodiments, the substrate is polyvinyl butyral (PVB) or other laminating material, such as a resin, a thermoplastic (e.g., a thermoplastic polyurethane), elastomer, or ethylene-vinyl acetate (EVA). A laminating material is any material that is capable of binding surfaces together. In some embodiments, the substrate can be swelled. In some embodiments, the laminating material is present as a layer on the surface of a substrate.

In some embodiments, the porous coating contains bilayers of different compositions. In some embodiments, the bilayers contain alternating layers of different and complementary compositions. By complementary is meant that the layers of different compositions interact with each other via complementary interactions, such as, electrostatic forces, Van der Waals forces, hydrogen bonding forces or specific binding forces (e.g., ligand-receptor binding forces). In some embodiments, the porous coating contains bilayers that include nanoparticles and a polymeric binder (e.g., a polyelectrolyte). For example, one monolayer comprises nanoparticles, and another monolayer comprises a polyelectrolyte. The combination of the two monolayers forms a bilayer. In some embodiments, the porous coating comprises a plurality of such bilayers. It is not necessary, however, that all of the bilayers in the coating be oriented in the same way (i.e. with either the polyelectrolyte or the nanoparticle monolayer always closer to the substrate). Each bilayer can be individually oriented in order to provide desired properties in the coating.

The nanoparticles may be porous or nonporous, hollow or solid, large or small, may possess an aspect ratio of 1 or much larger or smaller than 1, and may be comprised of one or a plurality of materials. Materials that are suitable for the nanoparticles include metal oxides, metal nitrides, metal sulfides, metals, ceramics, binary alloys, fullerenes, carbon onions, inorganic polymers, organic polymers, and hybrid materials. Examples of metal oxides include oxides of silicon, titanium, cerium, iron, chromium, copper, zinc, silver, cobalt, and the like. Specific examples of metal oxides include silicon dioxide, titanium dioxide, cerium(IV) oxide, and the like. Examples of metal nitrides include nitrides of titanium, aluminum, and the like. Specific examples of metal nitrides include titanium nitride, aluminum nitride, and the like. Examples of metals include silver, gold, copper, iron, zinc, aluminum, and the like. Inorganic polymers and hybrid polymers such as polydimethylsiloxane, polymethylhydrosiloxane, polymethylmethacrylate and the like may also be used. The nanoparticles may be spherical or non-spherical, with non-spherical shapes including rods, discs, and asymmetric shapes. In some embodiments, the nanoparticles have an average diameter within the range 1-1000 nm, or 1-500 nm, or 1-300 nm, or 1-200 nm, or 1-100 nm, or 1-75 nm, or 1-50 nm, or 2-50 nm, or 3-50 nm, or 4-50 nm, or 5-50 nm. For example, the nanoparticles may have an average diameter that is greater than 1 nm, or greater than 3 nm, or greater than 5 nm, or greater than 7 nm, or greater than 10 nm, or greater than 15 nm, or greater than 20 nm, or greater than 50 nm. Also for example, the nanoparticles may have a diameter that is less than 500, 300, 100, 50, 30, 20, 15, or 10 nm.

Mixtures of nanoparticles may be used. In some embodiments, each bilayer comprises a single type (e.g. material, size and shape) of nanoparticle, but nanoparticles in different bilayers are different. In some embodiments, the nanoparticles within a single bilayer may be different. For example, a single bilayer may comprise a bimodal distribution of spherical nanoparticles, or may comprise nanoparticles made of two different materials.

In some embodiments, the polyelectrolyte is an organic polymer or an inorganic polymer. For example, the polyelectrolyte is a polymer having an average molecular weight greater than 100 Da, or greater than 500 Da, or greater than 1,000 Da, or greater than 5,000 Da, or greater than 10,000 Da, or greater than 50,000 Da, or greater than 100,000 Da, or greater than 1 M Da. The repeating units may be of any size, from methylene oxide to larger repeat units containing one or more functional groups and heteroatoms. Examples of suitable polyelectrolytes include poly(diallyl dimethyl ammonium chloride) (PDAC), polyacrylic acid (PAA), poly(styrene sulfonate) (PSS), poly(vinyl alcohol) (PVA), poly(vinyl sulfonic acid), Chitosan, carboxymethylcellulose, poly(allylamine), hyaluronic acid, LPEI, BPEI, poly(3,4-ethylenedioxythiophene) (PEDOT) and combinations thereof with other polymers (e.g. PEDOT:PSS), copolymers of the above mentioned, and the like.

Further exemplary materials that may be used in the subject porous coatings include, but are not limited to: Germanium (Ge), Tellurium (Te), Gallium Antimonite (GaSb), Indium Arsenide (InAs), Silicon (Si), Indium Phosphate (InP), Gallium Arsenate (GaAs), Gallium Phosphate (GaP), Vanadium (V), Arsenic Selenide (As₂Se₃), CuAlSe2, Zinc Selenide (ZnSe), Titanium Dioxide (TiO₂), Alumina Oxide (Al₂O₃), Yttrium Oxide (Y₂O₃), Polystyrene, Magnesium Fluoride (MgF₂), Lead Fluoride (PbF₂), Potassium Fluoride (KF), Polyethylene (PE), Barium Fluoride (BaF₂), Silica (SiO₂), PMMA, Aluminum Arsenate (AlAs), Solgel Silica (SiO₂), N,N′ bis(lnaphthyl)-4,4′-diamine (NPB), Polyamide-imide (PEI), Chromium (Cr), Tin Sulfide (SnS), Low Porous Si, Chalcogenide glass, Cerium Oxide (CeO₂), Tungsten (W), Gallium Nitride (GaN), Manganese (Mn), Niobium Oxide (Nb₂O₃), Zinc Telluride (ZnTe), Chalcogenide glass+Ag, Zinc Sulfate (ZnSe), Titanium Dioxide (TiO₂), Hafnium Oxide (HfO₂), Sodium Aluminum Fluoride (Na₃AlF₆), Polyether Sulfone (PES), High Porous Si, Indium Tin Oxide (ITO), Lithium Fluoride (LiF₄), Calcium Fluoride, Strontium Fluoride (SrF₂), Lithium Fluoride (LiF), PKFE, Sodium Fluoride (NaF), Nano-porous Silica (SiO₂), Sputtered Silica (SiO₂), Vacuum Deposited Silica (SiO₂), and surface functionalized variations of the above mentioned.

In some embodiments, the porous coatings of interest comprise a polymer polyelectrolyte and a nanoparticle polyelectrolyte. In some embodiments, the porous coatings of interest contain only a single type of nanoparticle—i.e., they do not contain two or more different types of nanoparticles.

In some embodiments, in the subject porous coating, the porous structure of the film is defined by the vacant space between the materials that the film is composed of (e.g., pores created by the packing of a particulate material and/or polyelectrolyte), and is not defined by any porosity of the particulate material itself. In some embodiments, an encapsulant as described herein may be at least partially disposed within the pores created by the vacant space between the particulate materials and/or polyelectrolytes of the film, but not within the particles themselves. In some embodiments, the bilayers may be composed of materials that are porous or non-porous. For example, in some embodiments, the subject porous coating includes silica, where the silica may be non-porous or porous (e.g., a porous silica, such as a high, low or nanoporous silica).

The porous coatings may be produced using any convenient layer by layer (LbL) assembly process. For example, a spray or a dip LbL assembly process may be used to produce the subject porous coatings. Without wishing to be bound by theory, the assembly of the bilayers typically relies upon self-limiting interactions between the different and complementary compositions. For example, when complementary compositions that interact electrostatically are used, charge reversals that occur during deposition of each layer reduces the thermodynamic favorability of additional layers of molecules being absorbed to the growing film. In this way, films are grown a single layer at a time. Porosity of the film commonly results when a material such as air or solvent is trapped between layers.

Assembly of the porous coatings may be performed on a substrate that provides support for the growing film. Any convenient material may be used as a substrate. In some embodiments, a plurality of bilayers is deposited on the substrate to form a porous coating, e.g., using a LbL assembly process. In some embodiments, the plurality of bilayers is deposited on a substrate using a pair of deposition solutions, where one deposition solution includes a solvent and a polyelectrolyte, and the other deposition solution includes a solvent and nanoparticles. In some embodiments, the depositing of the solutions is via spray application in a layer-by-layer fashion. In some embodiments, the depositing of the solutions is performed using a spinning, spin-dipping, or dipping method in a layer-by-layer fashion. In some embodiments, a rinse solution is applied (either by dipping or by spraying) between each half bilayer formation. Optionally, following formation of the coating by application of the deposition solutions, drying of the coating may be performed prior to encapsulation.

In some embodiments, the porous coating contains at least a first portion of bilayers that has a refractive index n1, and at least a second portion of bilayers that has a refractive index n2. In some embodiments, the first portion and second portion of bilayers alternate in the porous coating. In some embodiments, the first portion of bilayers are grouped into a plurality of first groups, the second portion of bilayers are grouped into a plurality of second groups, and the first and second groups alternate in the porous coating. In some embodiments, the porous coating contains a plurality of portions of bilayers (e.g., B1, B2, B3, B4, B5, etc), where each portion of bilayers has a characteristic refractive index (e.g., n1, n2, n3, n4, n5, n6, etc). In some embodiments, the refractive indexes of each of the portions of bilayers are different. The portions of bilayers may be grouped using any convenient configuration to provide for a desired total refractive index. Any convenient arrangement of bilayers in the porous coating may be selected to provide for desired optical properties (e.g., a desired refractive index, a desired peak absorbance, or a desired peak reflectance) of the film. In embodiments, encapsulation of the porous coating with a hardening solution may or may not alter the optical properties (e.g., the overall refractive index) of the resulting coating.

In some embodiments, the thicknesses of the bilayers, the portions of bilayers and the thickness of the overall porous coating is selected to provide for a desired optical property (e.g., anti-reflectance). For example, the thicknesses may be selected based on particular wavelengths of light of interest, such as about quarter wavelength, half wavelength, eighth wavelength, etc. A plurality of layers or portions of bilayers with different thicknesses may also be selected to provide for a desired optical property. Any convenient optical design may be used, including thicknesses and arrangements of layers. Antireflection coatings make use of the interference effect of a thin layer. For example, if the layer's thickness is controlled such that it is one-quarter of the wavelength of the light (a quarter-wave coating), the reflections from the front and back sides of the thin layer will destructively interfere and cancel each other.

In some embodiments, at least two refractive indices are present in the porous coatings of interest, n1 and n2. In some such embodiments, n1 is greater than n2 by more than 10%, or more than 20%, or more than 30%, or more than 40%, or more than 50%, or more than 75%, or more than 100%. In some embodiments, n1 is greater than 1.7, 1.8, 1.9, 2.0, 2.1, 2.2, or 2.3. In some embodiments, n2 is less than 2.0, 1.9, 1.8, 1.7, 1.6, 1.5, or 1.4. In some embodiments, n1 and n2 differ by more than 0.1, 0.2, 0.3, 0.4, or 0.5.

In some embodiments, for example, n1 is the refractive index of a first bilayer A within a porous coating, and n2 is the refractive index of a second bilayer B within the porous coating. The porous coatings may comprise alternating layers ABABAB . . . , or may comprise various orientations of blocks of layers represented by Aₙ and Bₙ, such as AₙBₙAₙBₙ . . . , wherein each incidence of n is an independently selected integer. Although it may be assumed that the refractive index of a single bilayer A is the same as the refractive index of a plurality of contiguous bilayers Aₙ (wherein n is an integer greater than 1), this assumption is not necessary to the porous coatings of interest.

As an example, a porous coating is prepared having a plurality of first bilayers with a refractive index greater than 1.8 and a plurality of second bilayers with a refractive index less than 1.7.

### Methods for Application

The present disclosure provides methods for applying the hardening solution. Any convenient application method may be used, including but not limited to, Meyer-rod coating, gravure coating, slot die coating, spin coating, dipping methods, sputtering, spray coating and vapor deposition, and combinations thereof. In some embodiments, a spray coating method is used to apply the hardening solution. In some embodiments, a spin coating method is used to apply the hardening solution. Spray paint may be applied using propellant spray coating.

In some embodiments, excessive application or nonuniform application of the hardening solution is nonproblematic.

### Methods for Curing

The present disclosure provides methods for hardening the hardening solution. Depending on the chemistry of the hardening solution, hardening can be via the use of heat, UV, IR, magnetism, chemistry, evaporation, or time. Hardening can involve curing, crosslinking, setting, polymerization, evaporation of solvent, or the like, or combinations thereof.

Hardening refers to the application of any suitable conditions to a hardening solution that results in a material with increased hardness, strength, modulus or viscosity. Increased hardness may, for example, be assessed using a standard test method for film hardness by pencil test (e.g., ISO 15184).

In some embodiments, UV curing begins with the absorption of radiation by a photoinitiator, and the subsequent generation of an excited state species from the initiator. In some embodiments, this excited state species is a radical. In some embodiments, the activated initiator then reacts with monomers, oligomers and/or polymers. In some embodiments, these reactions are free radical polymerization reactions. In some embodiments, a nitrogen blanket is used to prevent oxygen inhibition.

In some embodiments, a crosslinking chemistry involves the thermally induced formation of amide bonds between acrylic acid and primary amine groups. In some embodiments, a crosslinking chemistry involves reaction between epoxide groups and amine or alcohol groups. In some embodiments, crosslinking involves carbodiimide chemistry. In some embodiments, crosslinking chemistry involves difunctional, trifunctional or multifunctional species where multiple covalent bonds can be formed form the same species.

In some embodiments, setting of an adhesive involves converting a liquid into a fixed or hardened state, typically accompanied by an increase in storage modulus or relaxation time. In some embodiments, setting involves the process of polymerization, gelation, evaporation of diluents or plasticizers, condensation or vulcanization.

In some embodiments, the coating includes nanoparticles and a polymeric binder. In some embodiments, the coating includes a crosslinked material permeating at least a portion of the bilayers. In some embodiments, the coating includes an adhesive material permeating at least a portion of the bilayers.

In some embodiments, the durable coating (i.e. the porous coating encapsulated as described herein) is delaminated from the substrate to form a free standing film. Such free standing films find use in a variety of applications, such as but not limited to, the production of durable coating particles.

In some embodiments, a non-stick film (either free-standing or as a coating on a substrate) is hardcoated using the methods disclosed herein. A layer-by-layer film is then deposited onto the non-stick film. A hardcoat film is then deposited on the LbL film, and the non-stick film is removed to produce a hardcoated LbL film. Examples of non-stick films include highly fluorinated films such as PTFE (i.e., TEFLON®) films.

### Encapsulated Porous Coating

The present disclosure provides an encapsulated porous coating (e.g., an encapsulated porous coating), which encapsulated porous coating can be provided in a variety of forms, e.g., free standing, as porous coating particles, or disposed on a substrate. The subject encapsulated porous coatings find use in a variety of applications, such as but not limited to, optical devices, semiconductor devices, cosmetic applications, and drug delivery applications.

In some embodiments, the encapsulated porous coating is a porous optical coating. In some embodiments, the porous coating is a dichroic mirror. In some embodiments, the porous coating is a filter (e.g., a dichroic filter) or a lens. In some embodiments, the porous coating provides for a particular reflection and/or transmission of electromagnetic radiation at various wavelengths. In some embodiments, the porous coating is responsive to a stimulus (e.g., light, heat, mechanical actuation, an electric or magnetic field). By responsive is meant that the film provides for an observable property (e.g., a color or a fluorescence), or a detectable change in an optical property of the film upon the application of the stimulus.

In some embodiments, the porous coating is part of a light emitting device (e.g., a semiconductor light emitting device).

In some embodiments, the porous coating is a dielectric coating, such as one that finds use in a capacitor or dielectric resonator.

In some embodiments, the porous coating is a transmissive porous coating that is an anti-reflection coating layer. The subject anti-reflective coatings find use in a variety of applications, for example, as an optical element of a laser system including high-energy lasers; an optical element of apparatuses, such as digital cameras, video cameras, and liquid crystal projectors, or other optical devices that require a reduced reflectance for an increase in optical efficiency; a protective film for solar cells, pictures, and displays; ophthalmic lenses, and data storage.

In some embodiments, the porous coating is a reflective coating, e.g., a UV-reflective coating or a coating that provides a visible color. In some embodiments, the porous coating is disposed on a clear substrate and has UV protection capabilities.

In some embodiments, the porous coating is 12″×12″ or greater in size, such as 2 feet×2 feet or greater. In some embodiments, the porous coating has combined linear dimensions (i.e., the sum of width and length) of 2 feet or more, such as 4 feet or more, 10 feet or more, 20 feet or more, or even larger. Alternatively, the porous coating may be smaller than 12″×12″.

In some embodiments, the porous coating has an average thickness of 10 mm or less, such as 1 mm or less, such as between about 10 nm and about 100 μm, between about 100 nm and about 10 μm, or between about 500 nm and about 5 μm. In some embodiments, the porous coating has an average thickness of between about 100 nm and about 10 μm, such as between about 500 nm and about 5 μm, or between about 500 nm and about 1 μm. In some embodiments, the porous coating an average thickness of about 1 μm or less, such as about equal to or less than 900, 800, 700, 600, 500, 400, 300, 200, or 100 μm.

Bilayer groups within a porous coating can have any convenient thickness based on the desired application, and this is exemplified by the following. As described above, the porous coating can be prepared having a plurality of bilayers that alternate or are arranged in a desired grouping. For example, the film can comprise a plurality of first groups of bilayers (wherein each group of bilayers comprises, e.g., five contiguous A bilayers, represented as A₅) and a plurality of second groups of bilayers (wherein each group of bilayers comprises, e.g., five contiguous B bilayers, represented as B₅). The A₅ groups have, for example, refractive index n1 and the B₅ groups have refractive index n2. For a film comprising the arrangement A₅B₅A₅B₅ . . . , the thickness of each A₅ group and the thickness of each B₅ group can be selected as desired, such as ¼λ, or ⅛λ, or ½λ, or the like (wherein λ is a predetermined wavelength).

In some embodiments, the encapsulated porous coating results from applying a porous coating to a laminating material and then encapsulating it between two surfaces. In some embodiments, the laminating material may mate two surfaces with the presence of the porous coating. Any suitable arrangement of one or more encapsulated coatings and one or more laminating materials and substrates may be selected to produce a laminate. In some embodiments, a laminating material is used to join the film with a hard material (e.g., glass). Examples of laminating material and laminated structures are provided in FIG. 1 and in the following description.

As used herein, the term “laminating material” refers to a material that can mate two surfaces or cover both sides of a single surface. For example, a laminating material may be a PVB substrate with a porous coating coating on top, or an adhesive material (which can include a porous coating) that allows the formation of a laminate. As used herein, the term “laminate” refers to a laminated product that includes at least one or two surfaces and a laminating material.

In some embodiments, the substrate is polyvinyl butyral (PVB). In some embodiments, the substrate can be swelled. In some embodiments, the substrate is a laminating material that may mate two surfaces (e.g., glass surfaces) such that the laminating material and the subject porous coating are located between the two surfaces to form a laminate. In some embodiments, the laminating material (e.g., EVA or PVB) is located as a coating on one side of the porous coating, whereby the porous coating may then be used to form a laminate. In some embodiments, the laminating material is located on both sides of the porous coating. In some embodiments, in a laminate, the laminating material permeates through the porous coating to contact surfaces on both sides of the porous coating. In some embodiments, laminating material (e.g., PVB)-coated porous coatings are located on both sides of a single surface (e.g., a glass sheet) to form a laminate.

Three embodiments of interest are now described. In embodiment (A), a porous coating is disposed on a substrate. In embodiment (B), a laminating layer (comprising a laminating material) is disposed on a porous coating, which is disposed on a substrate. This embodiment can be used to mate the substrate to, e.g., glass. In embodiment (C), the order of layers in the structure is: a laminating layer, a porous coating, a substrate, and a second laminating layer 120.

A further three embodiments of interest are now described. In embodiment (D), the order of layers is: first rigid layer (e.g., glass), laminating layer, porous coating, substrate, second laminating layer, and second rigid layer. In embodiment (E), a substrate layer also functions as a laminating material. Upon the substrate is disposed a porous coating, and upon the porous coating is disposed another laminating layer. Embodiment (F) builds upon embodiment (E). Thus, the order of the layers is: first rigid layer (e.g., glass), first laminating layer, porous coating, substrate (also functioning as a laminating layer), and second rigid surface.

In some embodiments, the subject encapsulated porous coating provides for a decrease or the elimination of problems of cracks, oxidation, environmental degradation, wrinkles or fogging. In some embodiments, the subject encapsulated porous coating provides for an increased hardness, strength and/or durability.

### Method for Creating Free Standing Encapsulated Porous Coating

The present disclosure provides methods for creating freestanding encapsulated porous coatings, and in some embodiments the encapsulated films of interest are freestanding porous coatings.

In some embodiments, the adhesion between encapsulated porous coating and substrate is designed to be weak and the adhesion between encapsulant and porous coating is strong. In such cases, the encapsulated porous coating may be removed from the substrate, e.g., removed without resorting to a mechanical force that might substantially damage the film. In some embodiments, the encapsulated porous coating is removed from the substrate using the force of a flow of fluid, such as water, solvent, air, nitrogen, or other ambient gas. In some embodiments, the encapsulated porous coating substantially maintains its structure. In some embodiments, the encapsulated porous coating maintains its original optical properties.

In some embodiments, the encapsulated porous coating can be removed from the substrate with physical bending or shearing of the substrate. In some embodiments, a sacrificial film can be applied to weaken adhesion of the porous coating to the substrate, where the sacrificial film is located between the porous coating and the substrate. Application of a suitable condition (e.g., heat, a solvent, a chemical reagent or a physical force) to the sacrificial film results in the separation of the substrate from the porous coating, where the sacrificial film may remain attached to the free standing porous coating, attached to the substrate, or may be removed from both (e.g., by disintegration, dissolution, etc.). In some embodiments, the sacrificial film can be dissolved away. In some embodiments, the sacrificial film can be removed by melting.

In some embodiments, the substrate can be dissolved away from the porous coating. In some embodiments, the substrate can be melted away from the porous coating. In some embodiments, the substrate can be removed from the porous coating by treatment of the substrate with a chemical reagent. In some embodiments, the substrate is selected such that the porous coating cracks upon exposure to the encapsulant solution.

In some embodiments, an adhesion promoter is present between the porous coating and the encapsulant (i.e., the hardened hardening material that forms the encapsulation layer). An example of an adhesion promoter is a silane material.

### Porous Coating Particles

In some embodiments, the encapsulated porous coatings of interest are porous coating particles, and the present disclosure provides methods for preparing such porous coating particles. In some embodiments, porous coating particles can be created by physical removal of a porous coating from a substrate. In some embodiments, the porous coating particles can be further milled down through mechanical means. In some embodiments, the porous coating substantially maintains its structure upon removal from the substrate. In some embodiments, the porous coating particles maintain their original optical properties. In some embodiments, the porous coating particles are flakes, particles, discs, or the like that can be mixed with a suitable carrier. In some embodiments, the porous coating particles are made to form composites with thermosets or thermoplastics. In some embodiments, the porous coating particles are mixed with other particles prior to being made into composites with thermosets and thermoplastics. In some embodiments, the porous coating particles are encapsulated prior to removal from the substrate. Such encapsulation may be by any of the methods and materials pertaining to encapsulation described herein. Thus, in some embodiments, the porous coating particles are protected (e.g., via an encapsulation layer) prior to dispersion in a carrier. The porous coatings forming the porous coating particles include those described herein, such as porous coatings prepared from polyelectrolytes and/or nanoparticles. In some embodiments, the porous coating particles are lighter in weight compared with non-porous particles of similar size.

### Dispersed Porous Coating Particles

The present disclosure provides coating formulations that include porous coating particles dispersed in a carrier, and methods for forming the same. The subject coating formulations find use is a number of applications, such as cosmetics, paints, and adhesives applications.

In some embodiments, the subject coating formulation is formed by depositing a plurality of bilayers on a substrate to form a porous coating, as described above, delaminating the porous coating from the substrate to form porous coating particles, and dispersing the porous coating particles in a carrier to form the coating formulation. In some embodiments, the porous coating is allowed to dry for a predetermined period of time, e.g., an amount of time sufficient for the coating to become fragmentable into particles. Any porous coating described herein may be used in forming the subject coating formulations.

In some cases, removal of a coating from a substrate may be referred to as “delaminating” the coating. In some embodiments, delaminating of a coating from a substrate produces particles of delaminated coating, where the particles may be characterized by their diameter (e.g., the largest linear dimension of the particle). In some cases, mechanical delamination can be achieved by scraping the substrate with a blade, or by flexing or bending the substrate to release the coating, or by any of the other methods described herein.

In some embodiments, delaminating the coating is achieved by chemical means. For example, immersion of the coating into a solvent, will cause fracture of the film making it easier to remove from the surface. Or as another example, the presence of the solvent will cause the adhesion between the coating and the substrate to be weakened. In some embodiments, the solvent is water. In some embodiments, the solvent is water with ionic species dissolved in it. In some embodiments, the solvent is acetone or ethanol. In some embodiments, a chemical means and a mechanical means are combined. For example, a method of delamination includes mechanical agitation of water over the coating. Furthermore, mechanical agitation of water over the coating, which has been fractured, may be a preferred embodiment. In some embodiments, some fraction of the bilayers will remain on the surface while a substantial portion of the porous coating will come free and be delaminated.

In some embodiments, the method of delaminating the coating is achieved by environmental or thermal means. For example humidity or temperature may be adjusted to cause fracture of the coating, enabling the delamination of the coating from the surface.

In some embodiments, delamination is achieved by dissolving, disintegrating or melting the substrate or a sacrificial layer (e.g., as described above) on the substrate. The sacrificial layer may be an additional new layer located between the substrate and the porous coating that is responsive to a stimuli (e.g., heat, solvent) that weakens the adhesion between the film and the substrate, as described above. After delamination the sacrificial layer could stay with the film or the substrate, or distintegrate or dissolve. In some embodiments, the substrate is reused after the coating is delaminated.

In some embodiments, the delaminated porous coating particles are in the form of flakes, discs, particles or a powder. In some embodiments, the subject method further includes milling the porous coating particles to a desired particle size prior to dispersing the particles. Any convenient milling method may be used in preparing porous coating particles of a desired particle size, such as an average diameter (i.e. largest dimension) between about 1 μm to about 10000 μm, such as between about 1 μm to about 1000 μm, between about 5 μm to about 500 μm, or between about 5 μm to about 50 μm. In some embodiments, the porous coating particles have an average diameter of equal to or less than about 1000, 900, 800, 700, 600, 500, 400, 300, 200, 100, 50, 20, or 10 μm. In some embodiments, the porous coating particles have an average thickness of between about 100 nm and about 10 μm, such as between about 500 nm and about 5 μm, or between about 500 nm and about 1 μm. In some embodiments, the porous coating particles have an average thickness (i.e. the smallest dimension) of equal to or less than about 1000, 900, 800, 700, 600, 500, 400, 300, 200, or 100 nm. In some embodiments, the delaminated coating may be fragmented to form particles in a subsequent fragmenting step, after delamination or removal of the coating from a substrate. In some embodiments, fragmentation of the coating into particles occurs in conjunction with delamination. Any convenient size of coating particles may be selected for use in the subject coating formulation.

In some embodiments, the delaminated coating is an encapsulated porous coating, as described above. For example, then, the method of forming dispersed porous coating particles involves depositing a plurality of bilayers on a substrate to form a porous coating, applying a hardening solution to the porous coating as described herein, hardening the hardening solution as described herein, delaminating the porous coating from the substrate to form porous coating particles, and dispersing the porous coating particles in a carrier to form the coating formulation. In some embodiments, the delaminated coating is a delaminated porous coating that is not encapsulated (i.e., does not include a hardened hardening material).

In some embodiments, when the coating particles are dispersed into a carrier, the carrier medium may permeate into the porous structure of the coating and can be described as encapsulating the coating particles, as described above. In some embodiments, the carrier medium is capable of hardening (e.g., a nail polish or a paint). In some embodiments, the coating particles are dispersed in a carrier medium where the carrier does not permeate into at least a portion of the porous structure of the particles, and where the particles may or may not be encapsulated prior to dispersion. In some embodiments, the porous coating particles are dispersed in the carrier in an amount in the range of 1-500 mg particles per 1 g carrier, such as 1-250 mg, 1-100 mg, 1-50 mg, 1-20 mg or 1-10 mg particles per 1 g carrier. In some embodiments, the presence of pores in the porous coating particles enables better adhesion of the particles to the surrounding dispersion (i.e., the carrier).

In some embodiments, the dispersion of porous coating particles in a carrier occurs at temperatures above room temperature. In some embodiments, the subject method further includes applying the coating formulation to a substrate.

The porous coating particles may be dispersed into any convenient carrier. In some embodiments the carrier is a cosmetics composition. In some embodiments, the resulting composition (e.g., a cosmetic) has desirable properties, such as an appropriate glossy or shiny effect, a homogeneous cosmetic film, a desired color appearance or color tone.

The cosmetic compositions produced by the above method may be used in various forms such as powder-like, cake-like, pencil-like, stick-like, gel-like, mousse-like, liquid-like, and cream-like states. The cosmetics may be used as base make-up cosmetics such as powder foundation, liquid foundation, oily foundation, mousse foundation, and pressed powder; point make-up cosmetics such as eye shadow, eyebrow; eye liner, mascara, nail polish, hair coloring, blush, and lip stick, etc.

In some embodiments, the porous coating particles are dispersed in a clear coat. In some embodiments, the dispersed coating formulation is used as nail polish. In some embodiments, the dispersed coating formulation is used as mascara. In some embodiments, the dispersed coating formulation is used as hair coloring. In some embodiments, the dispersed coating formulation is used as blush. In some embodiments, the dispersed coating formulation is used as tattoo ink. In some embodiments, the dispersed coating formulation is applied to a substrate and used in a cosmetic accessory, such as an artificial nail product. In some embodiments, the dispersed coating formulation is used as a lipstick. In some embodiments, the dispersed coating formulation is biocompatible and/or biodegradable. By biocompatible is meant that the dispersed coating formulation is inert and non-toxic to a subject (e.g., a human subject) to which the formulation is applied. By biodegradable is meant that the materials of the subject dispersed coating formulation are capable of being broken down after application to a subject into non-toxic components. Any convenient biocompatible and/or biodegradable materials may be used in the subject dispersed coating formulations, where, e.g., many such materials are available for use in cosmetic products.

In some embodiments, the porous coating particles are dispersed in a carrier such as a caulk, a sealant, an adhesive formulation, a paint, or the like. In some embodiments, the resulting formulations and coatings have properties, such as, an appropriate glossy or shiny effect, a desired color appearance or color tone, or a desired optical property, such as a UV reflecting property. In such cases, the subject formulations may find use in a variety of applications, such as construction materials, e.g., paints, sealants, caulks, and the like, or sunscreens where desired optical properties (as described above) can be selected by the inclusion of suitable porous coating particles in the formulation. The production of such construction materials that have desired aesthetic properties (e.g., a color or appearance) or useful optical properties (UV protection) is of great interest in the cosmetics, or materials and construction industries.

In some embodiments, the subject compositions find use in materials where resistance to copying is desirable (e.g., as an anti-counterfeiting measure in paper money, as a distinctive material having an optical property difficult to reproduce).

In some embodiments, the subject porous coating particles and compositions, find use in cosmetics formulations such as sunscreens, where the subject particles may impart desirable optical properties on the cosmetic formulation (e.g., UV absorption and reflecting properties).

In some embodiments, the subject coating formulation is a paint, a stain or a sealant that finds use as a coating with an optical property, such as reflection of UV light or a desirable visible color. In some embodiments, the subject coating formulation is a clear coating that has UV protection capabilities.

Any convenient carriers may be used in the subject dispersed coating formulations. In some embodiments, the carrier is a crosslinkable formulation, a thermoset formulation or a thermoplastic formulation. In some embodiments, the carrier medium may include a solvent such as but not limited to, water, alcohols (e.g. methanol, ethanol, isopropanol, butanol, benzyl alcohol, diacetone alcohol, 2-butoxyethanol, cyclohexanol); ketones (e.g. acetone, methyl ethyl ketone, methyl isobutyl ketone, cyclohexanone, diisobutyl ketone, isophorone); esters (e.g. methyl acetate, ethyl acetate, propyl acetate, butyl acetate, isopentyl acetate, methyl formate, ethyl formate, propyl formate, butyl formate); aliphatic hydrocarbons (e.g. hexane, cyclohexane); halogenated hydrocarbons (e.g. methylene chloride, chloroform, carbon tetrachloride); aromatic hydrocarbons (e.g. benzene, toluene xylene); amides (e.g. dimethylformamide, dimethylacetamide, n-methylpyrrolidone); ethers (e.g. diethyl ether, dioxane, tetrahydrofuran); glycols (e.g., ethylene glycol, propylene glycol, pentylene glycol, glycerol); and ether alcohols (e.g. 1-methoxy-2-propanol).

### Patterned Films

By combining the porous coating on a substrate such as PET with a pressure sensitive adhesive (or any other laminating material), and combining with another sheet of PET, for example, the entire laminated material can be subjected to post processing. The presence of the laminating adhesive provides some degree of protection to the film such that the laminate can be cut with a CAD-cutter, laser-cutter, CNC milling machine, etc. If the film is subjected to cutting without the presence of the laminating material, the film has a tendency to flake off at points, leaving a marred result. For clean patterning lines, therefore, the presence of the laminating material helps hold the film together.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described herein. It is understood that the present disclosure supersedes any disclosure of an incorporated publication to the extent there is a contradiction.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the disclosure. The upper and lower limits of these smaller ranges may independently be included or excluded in the range, and each range where either, neither or both limits are included in the smaller ranges is also encompassed within the disclosure, subject to any specifically excluded limit in the stated range. Where the stated range includes one or both of the limits, ranges excluding either or both of those included limits are also included in the disclosure.

It is to be understood that while the invention has been described in conjunction with the preferred specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains.

### Experimental

### Example 1

### Solution Preparation

100-200 k MW polydiallyldimethylammonium chloride (PDAC, 20 wt % solution) and tetramethyl ammonium hydroxide (TMAOH) were purchased from Sigma-Aldrich. 16.17 g of PDAC was added to a plastic cup, containing about 100 ml of deionized water. A stir bar was added and mixed using a stir plate, set to 200 rpm for 5 minutes. PDAC solution was transferred to a larger container, until 16.2 g of PDAC was combined with 983.8 g of deionized water, for a total weight of 1000.0 g. The solution was then stirred for 30 minutes at 700 rpm on a stir plate. Finally the pH of the solution was adjusted to 10.0 by adding TMAOH.

Silicon dioxide nanoparticle dispersions (AS-40, Ludox™), tetraethyl ammonium hydroxide (TEAOH) and tetraethylammonium chloride (TEACl) were purchased from Sigma-Aldrich. 1000 g of deionized water was added to a plastic container being stirred at 500 rpm on a stir plate. TEAOH was added to the water until a pH=12.0 was achieved. 8.29 g of TEACl was then added to the water until all the salt was dissolved. 25.0 g of AS-40 was then added to the plastic container and left to stir for 5 minutes.

Titanium dioxide nanoparticle dispersions (X500) were purchased from Titan PE. 1000 g of X500 was added to an empty plastic container. A stir bar was added to the container and stirred at 500 rpm. 8.29 g of TEACl was then added to 10 ml of deionized water in a separate 20 ml glass scintillation vial. The vial was closed tightly with a screw cap and shook until the salt was dissolved. Using a transfer pipette, the TEACl solution was added to X500 solution and stirred for an additional 5 minutes.

Rinse water was prepared by adding TMAOH to the deionized water until a pH of 10.0 was achieved.

### Example 2

### Layer-by-Layer Deposition of Optical Porous Films

Porous films were deposited onto 12″×12″ float glass (Asahi Glass Co.) using a deposition system (modeled after the systems described in US Patent Application Publication No. US 2010/0003499 to Krogman et al., as well as Krogman et al., Automated Process for Improved Uniformity and Versatility of Layer-by-Layer Deposition, Langmuir 2007, 23, 3137-3141). 11 PDAC-X500 bilayers (or cycles of PDAC-rinse-X500-rinse applied to the glass surface) were deposited for the formation of a high index film (HI). 7 PDAC-AS40 bilayers (or cycles of PDAC-rinse-AS40-rinse applied to the glass surface) were deposited for the formation of a low index film (LO). These numbers of bilayers were selected to create quarter wavelength optical thickness (QWOT) stacks for a 550 nm wavelength design. A 7-film architecture consisting of glass-HI-LO-HI-LO-HI-LO-HI was used to create the optical dichroic mirror. Reflectance measurements were made on a UV-Vis spectrophotometer (Shimadzu 3101) with data with a full width at half max of about 170 nm, which corresponds to a gold color. The color was confirmed by visual observation. Other optical porous films were deposited onto 12″×12″ float glass with different numbers of bilayers, targeting different QWOT wavelengths, for the generation of different colors.

### Example 3

### Formation of Porous Coating Particles

The porous films disposed on the glass surface were then removed through manual mechanical scraping of the porous film with a razor blade. As the razor was translated past the porous film, a white powder was formed and collected into a scintillation vial. The weight obtained from a 12″×12″ surface was approximately 200 mg. The presence of residual color (red, blue, green, or gold) was observed in the porous coating particles, indicating that the color from the porous films was retained even after delamination.

### Example 4

### Formation of Porous Film Particle Dispersion

Clear nail polish (Sally Hansen® Hard as Nails™ Xtreme wear 4860-01 Invisible color) was obtained at the CVS drug store. Approximately 100 mg of the porous coating particles were added to a 11.8 ml container of nail polish along with two ball bearings. The suspensions were shaken on a vortexer for several minutes until a milky, opalescent dispersion was formed. The suspensions exhibited color which was attributed to the suspended porous coating particles.

### Example 5

### Application of Porous Film Particle Dispersions

Using the brush applicator that comes with the nail polish, the porous film particle dispersion was applied to fake nails that had been previously covered with black nail polish as a back side absorber. The porous film dispersion was allowed to dry for 2 hours, allowing for sufficient time for setting. The nails were then checked for tackiness and mechanical durability. Reconstituted colors were observed in the coatings; these colors were attributed to the porous coating particles. At least one of the examples was observed to exhibit the angular dependence associated with multilayer dichroic mirror reflectors.

### Example 6

### Encapsulating Porous Film Using Acrylate Composition

A 7-film QWOT porous film was deposited onto polycarbonate (Lexan), following a similar procedure described in Example 1. A UV-curable optical hardcoat formulation (mixture of SR238B, SR454, SR494, obtained from Sartomer Inc. and Irgacure 184, obtained from BASF), was rod-coated onto the porous film. The encapsulated porous film was then exposed to UV radiation under a N₂ blanket, resulting in an abrasion resistant encapsulated porous film.

### Example 7

### Encapsulating Porous Film Using Spray Paint

A 9-film QWOT porous film was deposited onto an 18″ wide×36″ area of polyethylene terepthalate (Melinex 454, Dupont-Teijin), following a similar procedure described in Example 1. The film demonstrated very good uniformity with thickness variation of less than 15 nm in total film thickness over the 18″×36″ area. The film was taped to cardboard, film side up. Black spray paint (Valspar) was purchased from a commercial supplier. In a well ventilated indoor area and after vigorous shaking a generous amount of spray paint was applied to the porous film. The paint was allowed to dry overnight before a second application of spray paint was applied. The encapsulated porous film was observed visibly to confirm desired optical qualities. For example, with the painted side facing a wall and the substrate facing the viewer, the encapsulated porous film was observed to have reflective properties. The black spray paint acts to provide backside absorption.

### Example 8

### Lamination of Porous Film

A 9-film QWOT porous film was deposited onto borosilicate glass (purchased from McMaster-Carr), following a similar procedure described in Example 1. The film was then covered by a sheet of polyvinylbutyral (obtained from Asahi Glass Company), followed by another piece of borosilicate glass. The assembly was then clamped together using workbench vises and placed in a furnace at 150 degrees C. for 25-30 minutes. The assembly was then removed from the furnace and allowed to cool to room temperature, with the final film laminated between two pieces of glass being observed visibly to confirm desired optical qualities.

### Example 9

### Porous Film

An exemplary film on PET encapsulated between two pieces of glass using polyvinylbutyral, a lamination adhesive, was prepared and visibly observed to maintain its spectral properties (i.e. color).

### Example 10

### Porous Coating Particles

SEM images of porous coating particles prepared according to embodiments of the disclosure were taken. The images show a pile of porous coating particles showing a typical size of (40 μm length×10 μm width×1 μm thickness), and a close-up view of particles (i.e., flakes) on edge. The thickness of the particles on edge, indicate equivalent thicknesses to the as deposited film, prior to delamination. Another image shows the cross sections of flakes which indicate the layered structure of porous coating particles, demonstrating both good inter-layer and intra-layer uniformity.

### Example 11

### Patterning a Structure Having a Porous Film

A porous dichroic mirror of example 2 was deposited onto PET (Melinex 582S). One protective sheet of PET was removed from 2-sided pressure sensitive adhesive (PSA) and applied and rolled onto the film side of the dichroic mirror. The result was a sandwich of PET-porous coating- PSA-protective PET cover. The laminate was mounted onto a tacky cutting board (Silhouette) and cut using a Silhouette Cameo 2-D cutter.

What is claimed is:

1. A method for producing an encapsulated coating, comprising:
(a) applying a hardening material to a surface of a porous coating, wherein the porous coating comprises an open pore structure and a plurality of bilayers disposed on a substrate, and wherein the hardening material permeates into at least a portion of the open pore structure of the porous coating; and
(b) applying hardening conditions to harden the hardening material and form the encapsulated coating comprising hardened hardening material disposed on the surface of the porous coating and within at least a portion of the open pore structure of the porous coating.

2. The method of claim 1, wherein the hardened hardening material permeates to a depth of less than about 50 nm below the surface of the porous coating.

3. The method of claim 1, wherein the hardened hardening material is a transparent, semi-transparent, or opaque solid material.

4. The method of claim 1, wherein the hardening material permeates through the open pore structure of the porous coating to contact the substrate.

5. The method of claim 1, wherein the hardening material is selected from a polymer, a crosslinkable polymer, a polymerizable monomer, an adhesive, and combinations thereof.

6. The method of claim 1, further comprising delaminating the encapsulated coating from the substrate to form a free standing film.

7. The method of claim 1, wherein an adhesion promoter is present on the surface of the porous coating prior to applying the hardening material.

8. The method of claim 1, comprising depositing the plurality of bilayers in a layer-by-layer fashion and drying the porous coating prior to applying the hardening material.

9. The method of claim 1, wherein the encapsulated coating is more durable compared with the porous coating lacking the hardened hardening material.

10. A coating material comprising particles of a first material dispersed in a carrier, wherein the particles comprise a plurality of bilayers and are porous.

11. The coating material of claim 10, wherein each bilayer of the plurality of bilayers comprises a pair of complementary materials capable of forming a chemical bond.

12. The coating material of claim 10, wherein the particles further comprise a hardened hardening material that is at least partially disposed within the porous structure of the first material.

13. A method for forming the coating material of claim 10, the method comprising:
(a) depositing the plurality of bilayers on a substrate to form a porous coating;
(b) drying the porous coating for a predetermined period of time;
(c) delaminating the porous coating from the substrate to form particles;
(d) dispersing the particles in the carrier.

14. The method of claim 13, comprising depositing a hardening material on the porous coating after the predetermined period of time and hardening the hardening material.

15. An article comprising, in order:
a first substrate;
a porous coating comprising a plurality of bilayers and having an open pore structure, wherein at least a portion of the bilayers comprise nanoparticles and a polyelectrolyte; and
a laminating material.

16. The article of claim 15, comprising a laminating material disposed between the first substrate and the porous coating.

17. The article of claim 15, wherein the substrate is patterned, the porous coating is patterned, the laminating material is patterned, or a combination of the substrate, porous coating, and laminating material is patterned.
